(19) United States
(12) Patent Application Publication
(10) Pub. No.: US 2013/0212574 A1
(43) Pub. Date: Aug. 15, 2013

(54) Sub-Device Discovery and Management

(71) Applicants: Jonathan David Hutchinson, Snohomish, WA (US); Douglas Graham King, Sammamish, WA (US); Ziad Elmalki, Redmond, WA (US); Rinku Sreedhar, Sammamish, WA (US)

(72) Inventors: Jonathan David Hutchinson, Snohomish, WA (US); Douglas Graham King, Sammamish, WA (US); Ziad Elmalki, Redmond, WA (US); Rinku Sreedhar, Sammamish, WA (US)

(73) Assignee: MICROSOFT CORPORATION, Redmond, WA (US)

(21) Appl. No.: 13/396,072

(22) Filed: Feb. 14, 2012

(51) Int. Cl. G06F 9/445; G06F 15/177

(52) U.S. Cl. 717/172; 713/1

(57) ABSTRACT

A sub-device agent running on a network device provides tools for detecting and managing sub-devices connected to the network device. The sub-device agent reports the presence of the sub-devices to a configuration manager, which provides a user interface for managing the sub-devices. The sub-devices are not directly detectable by or visible to the configuration manager. The sub-device agent provides access to the sub-devices for monitoring, configuring, updating, etc. The sub-device agent may be used to install or upgrade firmware or software on the sub-device or to monitor a status of the sub-device. Sub-device modules, such as OEM plug-ins and drivers, may be used by the sub-device agent to discover and manage the sub-devices.

### BACKGROUND

Organizations often must manage multiple IT resources, such as personal computers, servers, and specialized devices. These resources typically are connected to one or more peripherals, components or other sub-devices. There is no currently available solution that allows an organization to access or view these peripherals or sub-devices. Organizations do not have tools that allows for integrated management of the IT resources and sub-devices. As a result, critical information at the sub-device level, such as status information, is not available to the organization. Also, operating system updates and other software changes cannot be pushed to the sub-devices from a central management site.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, a configuration manager is coupled to one or more network devices. A management agent resides on the network devices and is configured to communicate with the configuration manager. The management agent includes a discovery module that is adapted to identify sub-devices that are coupled to the network device and to report the presence of the sub-devices to the configuration manager. The management agent further comprises a management module that is adapted to receive commands associated with the sub-devices from the configuration manager.

The sub-devices may be logically or physically coupled to the network device, but the sub-devices are not directly visible to the configuration manager. The management module may receive firmware or software upgrades for the sub-devices from the configuration manager and installs these upgrades to the sub-device as directed by the configuration manager. The management module may modify a configuration of the sub-devices and/or may monitor a status of the sub-devices. A module or modules in the management agent, such as an OEM plug-in or a driver, provided by the sub-device manufacturers may provide data that assists in managing the sub-devices.

### DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram illustrating a configuration manager server and client agent providing discovery and management of network sub-devices;

FIG. 2 is a block diagram illustrating a sub-device agent running on a network device and providing discovery and management of sub-devices;

FIG. 3 is a block diagram of a network employing configuration manager agents in network devices to discover and manage sub-devices; and

FIG. 4 is a flowchart of a process or method for discovering and managing sub-devices in a network.

### DETAILED DESCRIPTION

Embodiments of the invention allow a network operator to discover and manage sub-devices connected that are connected to network devices. The sub-devices may be any type of peripheral or other component that is logically connected to a network device, such as a personal computer, server, or specialized network device. The configuration manager is initially aware of just the devices that make up the network and then discovers the sub-devices that are coupled to the network through the network devices. This allows the configuration manager to gather data about the sub-devices, such as identifying the sub-device's hierarchical relationship with a network device.

Once the sub-devices are identified, the configuration manager can monitor and manage the sub-devices. The sub-devices may be categorized, organized or grouped based on criteria such as sub-device type, OEM name, or parent network device identity or type. This information about the sub-devices on the network provides asset management and compliance for the sub-devices, such as firmware upgrades, software distribution, and configuration changes, and enables reporting of enhanced business intelligence.

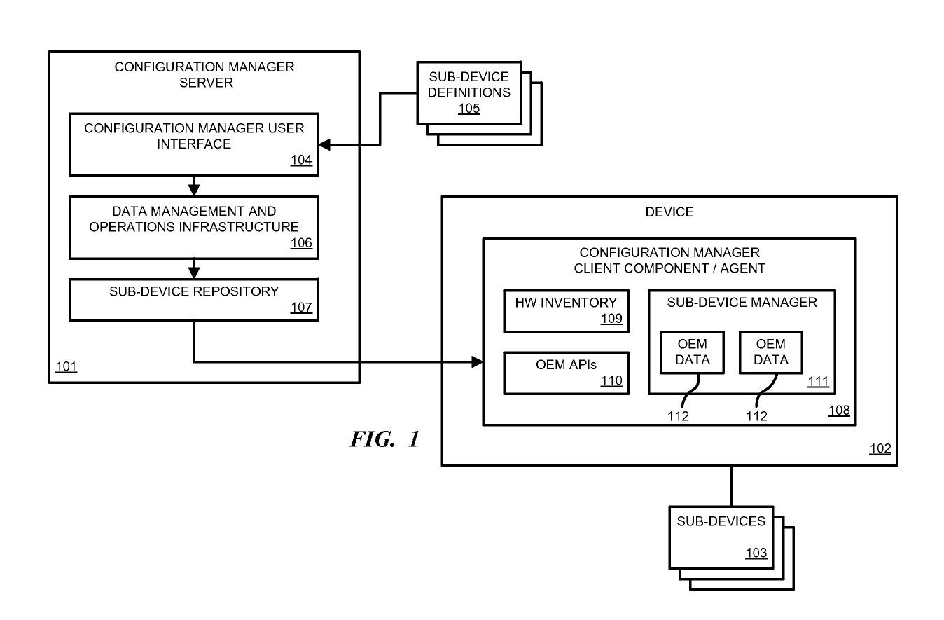

FIG. 1 is a block diagram illustrating a configuration manager server and client agent providing discovery and management of network sub-devices. Configuration management server 101 is a network management entity that allows a network operator or IT administrator to manage network device 102 and sub-devices 103. User interface 104 provides a console or viewer for operators or administrators. User interface 104 may provide a sub-device specific interface or user experience based upon sub-device definitions 105, which may use XML or metadata to describe sub-devices 103 and their capabilities. Data management and operations infrastructure 106 supplies management data to other parts of the operating system. Sub-device repository 107 stores sub-device definition data and an inventory or sub-devices 103 discovered on the network.

Configuration manager client component 108 is an agent that resides on network device 102 and reports the sub-devices 103 connected to the network device 102. Hardware inventory 109 retrieves and stores an inventory of sub-device data, such as the software, configuration and services associated with sub-device 103. The configuration manager agent 108 can use OEM APIs 110 to access sub-devices 103. The sub-device OEMs create APIs 110 to provide the OEMs' own data and to define properties of the sub-devices 103. Configuration manager agent 108 includes sub-device manager 111 that provides management and discovery of sub-devices 103 using OEM data 112, which may be sub-device drivers or plug-ins that enable sub-device-specific action.

Sub-device definition 103 is imported into the configuration manager server 101 and is passed and goes down to network device 102 via agent 108. The configuration manager agent 108 collects sub-device information and reports to configuration manager server 101, which updates the hardware inventory for network device 102. Data management and operations infrastructure 106 manages the collected sub device inventory, enumerates the sub-devices by the primary device's identifier, and enumerates the sub-device classes.

The sub-devices may be addressed indirectly via the primary devices either by individual device or in groups of network devices with specific sub-devices attached. OEM data component 112 specifies supported configuration settings for a sub-device 103. Configuration manager server 101 may use custom APIs to access device-specific properties in sub-devices 103. The sub-device manager 111 is used by the configuration management agent 108 for configuration and inventory collection. The sub-device manager 111 carries out management functions by calling into OEM plugin 112.

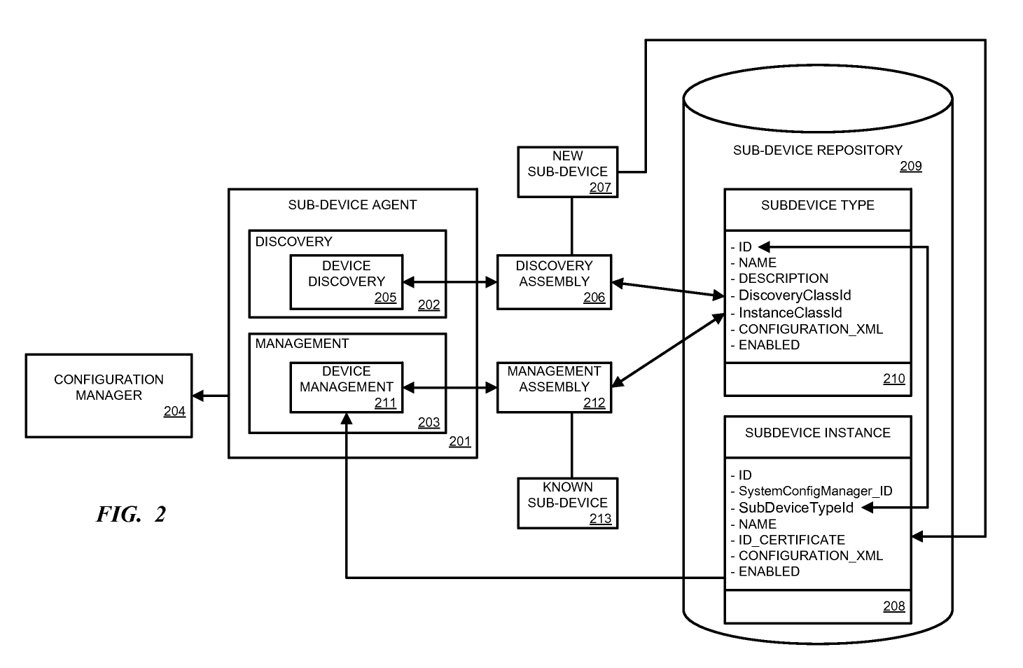

FIG. 2 is a block diagram illustrating a sub-device agent 201 running on a network device and providing discovery and management of sub-devices. Sub-device agent 201 comprises a discovery module 202 and a management module 203. The sub-device agent 201 and management module 203 communicate with a configuration manager 204, which provides an interface to the configuration manager and allows a network operator or IT administrator to perform actions on the sub-devices.

Discovery module 202 runs a device discovery process 205 against a discovery assembly 206 to identify new sub-devices 207 that are connected to the network device. The discovery process 205 may be, for example, an instance of a discovery class. When a new sub-device is discovered, then discovery module 202 creates a new sub-device instance 208 in a sub-device repository 209. Sub-device repository 209 stores information on sub-device types and instances, such as which sub-device is connected to which machine. The sub-device instance 208 may be an instance of a sub-device type 210, which includes classes that can be used to discover new sub-devices (e.g. DiscoveryClassId) or to manage the sub-devices (e.g. InstanceClassId). The relationship between the sub-device instance 208 and sub-device type 210 may be indicated in a reference to the sub-device type's identifier (e.g. SubDeviceTypeId).

Management module 203 runs a device management process 211 on management assembly 212 to control and manage known sub-devices 213 that may have been previously discovered using discovery module 202.

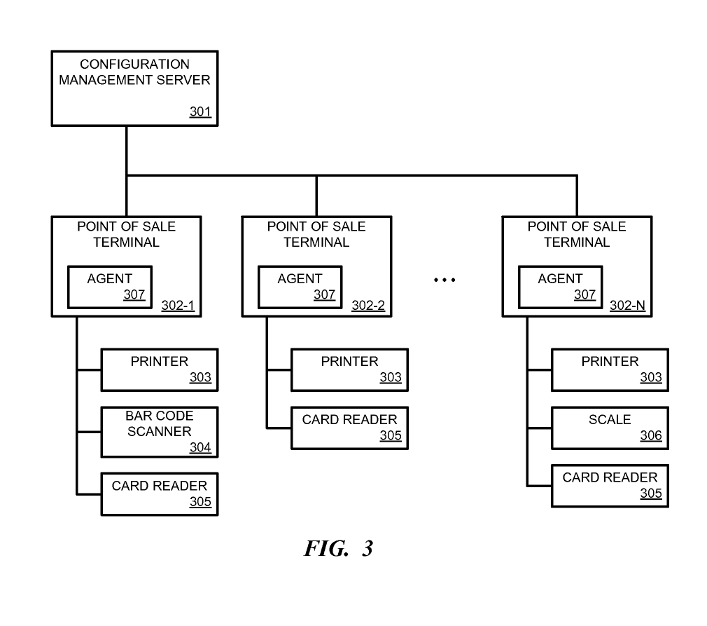

FIG. 3 is a block diagram of a network employing configuration manager agents in network devices to discover and manage sub-devices. Configuration management server 301 is coupled to, and is aware of, top-level network devices 302, which may be a group of point of sale (POS) terminals in a store for example. Each POS terminal 302 may have a different set of sub-devices attached. For example, depending upon where a POS terminal 302 is located in the store, it may have a printer 303, bar code scanner 304, card reader 305, and/or scale 306 attached.

Each POS terminal 302 has a configuration manager agent 307 running on it. The configuration manager agent 307 discovers sub-devices 303-306 coupled to each POS terminal 302 and reports the sub-devices 303-306 to configuration management server 301. The configuration manager agent 307 may use management point APIs to register discovered sub-devices as peer devices to POS terminals. The sub-devices may then be displayed to users via the configuration management server 301. The properties of the various sub-devices may be reported as a hardware inventory of sub-devices 303-306. The configuration management server 301 maintains collections of sub-devices that can be addressed individually.

The configuration manager agent 307 may be implemented, for example, as a sub-device proxy client that downloads policies from a management point associated with the configuration management server 301. The agent 307 provides functions such as reporting an inventory of sub-devices for each POS terminal 302, executing desired configuration management actions, distributing and loading software relevant to the sub-devices. The sub-device agent processes and carries out configuration management server 301 policies on behalf of the sub-device by duplicating the configuration management server functionality, for example.

In one embodiment, a network administrator can only see POS terminals 302 (i.e. network devices) and is not aware of what sub-devices may be present on the network (i.e. connected to POS terminals 302). Agents 307 identify the sub-devices 303-306 on each POS terminal 302 and report the inventory of sub-devices to configuration management server 301, which allows the administrator to view a list of all sub-devices and their hierarchical relationship to the POS terminals 302 or other network devices. Agents 307 may use OEM plug-ins or drivers to gather sub-device-specific data. For example, an OEM plug-in for a printer sub-device 303 may allow an agent 307 to detect and report on ink and paper levels in the printer 303 or to report and update a software or firmware version loaded on the printer 303. The information about the sub-devices 303-306 provided by agent 307 allows the network administrator to proactively manage the network, ensure currency of software and firmware on the sub-devices, and verify sub-device compliance with network policies.

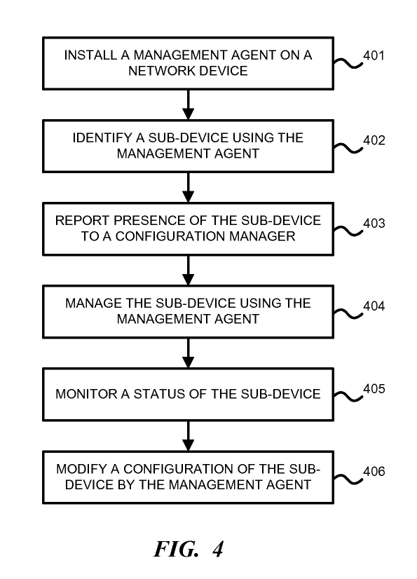

FIG. 4 is a flowchart of a process or method for discovering and managing sub-devices in a network. In step 401, a management agent is installed on a network device. The management agent is configured to communicate with a configuration manager. The configuration manager may be part of network or system configuration management device, for example, that sees network devices, but does not see sub-devices that are logically or physically coupled to the network devices. In step 402, a sub-device is identified using the management agent. The sub-device is coupled to the network device and is not directly detectable by the configuration manager. In step 403, the presence of the sub-device is reported to the configuration manager.

In step 404, the sub-device is managed by the management agent based upon commands from the configuration manager. The management agent may upgrade and/or install software or firmware to the sub-device, for example. In step 405, the status of the sub-device is monitored by the management agent, which may report the status to the configuration manager. The management agent may use a module provided by the sub-device manufacturer, such as an OEM plug-in or a driver, to manage and monitor the sub-device. In step 406, the configuration of the sub-device is modified by the management agent based upon commands from the configuration manager.

It will be understood that steps 401-406 of the process illustrated in FIG. 4 may be executed simultaneously and/or sequentially. It will be further understood that each step may be performed in any order and may be performed once or repetitiously.

The network devices, sub-devices and configuration manager may be embodied with numerous general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

An exemplary system for implementing various aspects of the invention may include a general purpose computing device in the form of a computer. Components may include, but are not limited to, various hardware components, such as a processing unit, data storage, such as a system memory, and a system bus that couples various system components including the data storage to the processing unit. The system bus may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer typically includes a variety of computer-readable media. Computer-readable media may be any available media that can be accessed by the computer and includes both volatile and nonvolatile media, and removable and non-removable media, but excludes propagated signals. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media. Computer-readable media may be embodied as a computer program product, such as software stored on computer storage media.

The data storage or system memory includes computer storage media in the form of volatile and/or nonvolatile memory such as read only memory (ROM) and random access memory (RAM). A basic input/output system (BIOS), containing the basic routines that help to transfer information between elements within computer, such as during start-up, is typically stored in ROM. RAM typically contains data and/or program modules that are immediately accessible to and/or presently being operated on by a processing unit. By way of example, and not limitation, data storage holds an operating system, application programs, and other program modules and program data.

Data storage may also include other removable/non-removable, volatile/nonvolatile computer storage media. By way of example only, data storage may be a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The drives and their associated computer storage media as described above provide storage of computer-readable instructions, data structures, program modules and other data for the computer.

A user may enter commands and information through a user interface or other input devices such as a tablet, electronic digitizer, a microphone, keyboard, and/or pointing device, commonly referred to as mouse, trackball or touch pad. Other input devices may include a joystick, game pad, satellite dish, scanner, or the like. Additionally, voice inputs, gesture inputs using hands or fingers, or other natural user interface (NUI) may also be used with the appropriate input devices, such as a microphone, camera, tablet, touch pad, glove, or other sensor. These and other input devices are often connected to the processing unit through a user input interface that is coupled to the system bus, but may be connected by other interface and bus structures, such as a parallel port, game port or a universal serial bus (USB). A monitor or other type of display device is also connected to the system bus via an interface, such as a video interface. The monitor may also be integrated with a touch-screen panel or the like. Note that the monitor and/or touch screen panel can be physically coupled to a housing in which the computing device is incorporated, such as in a tablet-type personal computer. In addition, computers such as the computing device may also include other peripheral output devices such as speakers and printer, which may be connected through an output peripheral interface or the like.

The computer may operate in a networked or cloud-computing environment using logical connections to one or more remote devices, such as a remote computer. The remote computer may be a personal computer, a server, a router, a network PC, a peer device or other common network node, and typically includes many or all of the elements described above relative to the computer. The logical connections may include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computer may be connected to a public or private network through a network interface or adapter. In some embodiments, a modem or other means for establishing communications over the network. The modem, which may be internal or external, may be connected to the system bus via the network interface or other appropriate mechanism. A wireless networking component such as comprising an interface and antenna may be coupled through a suitable device such as an access point or peer computer to a network. In a networked environment, program modules depicted relative to the computer, or portions thereof, may be stored in the remote memory storage device. It may be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A device, comprising:
a management agent configured to communicate with a configuration manager, the management agent comprising:
a discovery module adapted to identify a sub-device coupled to the device and to report the presence of the sub-device to the configuration manager; and
a management module adapted to receive sub-device commands from the configuration manager.

2. The device of claim 1, wherein the sub-device is logically coupled to the device.

3. The device of claim 1, wherein the sub-device is physically coupled to the device.

4. The device of claim 1, wherein the sub-device is not directly discoverable by the configuration manager.

5. The device of claim 1, the management module further adapted to receive firmware upgrades for the sub-device from the configuration manager and to install the firmware upgrades to the sub-device.

6. The device of claim 1, the management module further adapted to receive software upgrades for the sub-device from the configuration manager and to install the software upgrades to the sub-devices.

7. The device of claim 1, the management module further adapted to modify a configuration of the sub-device.

8. The device of claim 1, the management module further adapted to monitor a status of the sub-device.

9. The device of claim 1, further comprising:
a sub-device-manufacturer module in the management agent, the sub-device-manufacturer module comprising data adapted to manage the sub-device.

10. The device of claim 1, further comprising:
a sub-device-manufacturer module in the management agent, the sub-device-manufacturer module comprising data adapted to discover the sub-device.

11. The device of claim 9, wherein the sub-device-manufacture module is an OEM plug-in.

12. The device of claim 9, wherein the sub-device-manufacture module is a driver.

13. A method, comprising:
installing a management agent on a network device, the management agent configured to communicate with a configuration manager;
identifying a sub-device using the management agent, the sub-device coupled to the network device and not directly detectable by the configuration manager;
reporting the presence of the sub-device to the configuration manager; and
managing the sub-device using the management agent based upon commands from the configuration manager.

14. The method of claim 13, wherein the sub-device is logically or physically coupled to the network device.

15. The method of claim 13, further comprising:
receiving software or firmware upgrades at the management agent from the configuration manager; and
installing the software or firmware upgrades to the sub-device by the management agent.

16. The method of claim 13, further comprising:
modifying a configuration of the sub-device by the management agent based upon commands from the configuration manager.

17. The method of claim 13, further comprising:
monitoring a status of the sub-device by the monitoring agent; and
reporting the status to the configuration manager.

18. The method of claim 13, further comprising:
accessing a sub-device-manufacturer module in the management agent to manage or discover the sub-device, the sub-device-manufacturer module in the management agent, the sub-device manufacturer module comprising data adapted to discover the sub-device.

19. The method of claim 18, wherein the sub-device-manufacture module is an OEM plug-in or a driver.

20. A computer system, comprising:
one or more processors;
system memory;
one or more computer-readable storage media having stored thereon computer-executable instructions that, when executed by the one or more processors, causes the processors to perform a method for discovering and managing sub-devices, the processor operating to:
install a management agent on a network device, the management agent configured to communicate with a configuration manager;
identify the sub-devices using the management agent, the sub-devices coupled to a network device and not directly detectable by the configuration manager;
report the presence of the sub-devices to the configuration manager; and
modify a configuration of the sub-device by the management agent based upon commands from the configuration manager.
